(19) United States
(12) Patent Application Publication
(10) Pub. No.: US 2012/0114281 A1
(43) Pub. Date: May 10, 2012

(54) SYSTEM AND METHOD FOR FREE-SPACE OPTICAL INTERCONNECTIONS

(75) Inventors: Tian Gu, Newark, DE (US); Michael W. Haney, Oak Hill, VA (US); Rohit Nair, Newark, DE (US)

(73) Assignee: University of Delaware, Newark, DE (US)

(21) Appl. No.: 13/318,920

(22) PCT Filed: May 4, 2010
(86) PCT No.: PCT/US2010/033529

§ 371 Date: Jan. 13, 2012

Related U.S. Application Data
(60) Provisional application No. 61/175,196, filed on May 4, 2009.
(60) Provisional application No. 61/240,431, filed on Sep. 8, 2009.
(60) Provisional application No. 61/297,526, filed on Jan. 22, 2010.

(51) Int. Cl. G02B 6/12; G02B 6/26

(52) U.S. Cl. 385/14

(57) ABSTRACT

Optical interconnect systems and methods are disclosed. An optical interconnect system includes a substrate, a first waveguide, and a free-space coupling structure. The first waveguide is disposed on the substrate. The free-space coupling structure is adjacent the first waveguide. The free-space coupling structure redirects light propagating through the first waveguide in a first direction out of the first waveguide in a second direction different from the first direction. An optical interconnect method comprises transmitting light through a first waveguide in a first direction; and redirecting the light out of the first waveguide in a second direction different from the first direction with a free-space coupling structure disposed in the first waveguide.

### CROSS REFERENCE TO RELATED APPLICATIONS

This application claims the benefit of provisional U.S. Patent Application No. 61/175,196, filed May 4, 2009; provisional U.S. Patent Application No. 61/240,431, filed Sep. 8, 2009; and provisional U.S. Patent Application No. 61/297,526, filed Jan. 22, 2010, each of which is fully incorporated herein by reference.

### FIELD OF THE INVENTION

The present invention relates to optical circuitry, and more particularly, to free-space optical interconnections.

### BACKGROUND OF THE INVENTION

Conventional integrated circuits employ metal interconnections, i.e. metal wires, for chip-scale communication (e.g, on-chip and chip-to-chip interconnects). The requirements of speed and processing power in computing continues to push the industry to smaller and smaller integrated circuits. As it does so, metal interconnections on integrated circuits may become problematic due to size, layout, and/or power constraints. Integrated circuits that employ optical interconnections may provide a viable solution to the growing bandwidth requirements in modern microprocessors. As demands on performance for microprocessors increase, improvements in optical interconnections are desired.

### SUMMARY OF THE INVENTION

The present invention is embodied in systems and methods for free-space optical interconnections.

In accordance with one aspect of the present invention, an optical interconnect system is disclosed. The optical interconnect system includes a substrate, a first waveguide, and a free-space coupling structure. The first waveguide is disposed on the substrate. The free-space coupling structure is adjacent the first waveguide. The free-space coupling structure redirects light propagating through the first waveguide in a first direction out of the first waveguide in a second direction different from the first direction.

In accordance with another aspect of the present invention, an optical interconnect method is disclosed. The optical interconnect method comprises the steps of transmitting light through a first waveguide in a first direction; and redirecting the light out of the first waveguide in a second direction different from the first direction with a free-space coupling structure disposed in the first waveguide.

In accordance with yet another aspect of the present invention, an optical interconnect system is disclosed. The optical interconnect system includes a substrate, a waveguide, a light-redirecting element, and a free-space coupling structure. The waveguide is disposed on the substrate. The light-redirecting element is disposed adjacent the waveguide. The light-redirecting element is configured to direct light propagating in a first direction in a second direction into the waveguide. The free-space coupling structure is adjacent the waveguide. The free-space coupling structure is configured to redirect light propagating through the waveguide in the second direction out of the waveguide in a third direction different from the first and second directions.

In accordance with still another aspect of the present invention, an optical interconnect method is disclosed. The optical interconnect method comprises the steps of transmitting light in a first direction with a light source, redirecting light into a waveguide with a light-redirecting element, the light-redirecting element redirecting the light in a second direction different from the first direction, and redirecting the light out of the waveguide with a free-space coupling structure, the free-space coupling structure redirecting the light in a third direction different from the first and second directions.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale. On the contrary, the dimensions of the various features may be expanded or reduced for clarity. Included in the drawings are the following figures:

FIG. 1 is a perspective view of an exemplary optical interconnect system in accordance with aspects of the present invention;

FIG. 2A is a cut away side view of the optical interconnect system of FIG. 1;

FIG. 2B is a cut away side view of an alternative exemplary embodiment of the optical interconnect system of FIG. 1;

FIG. 3 is an alternative cut away side view of the optical interconnect system of FIG. 1;

FIG. 4 is an illustrative side view of an exemplary coupling structure of the optical interconnect system of FIG. 1;

FIG. 5 is an illustrative side view of an alternative exemplary coupling structure of the optical interconnect system of FIG. 1;

FIG. 6 is an illustrative side view of another alternative exemplary coupling structure of the optical interconnect system of FIG. 1;

FIG. 7 is an illustrative view of the path of a light beam through the coupling structure of FIG. 4;

FIG. 8 is an illustrative view of the path of a light beam through the coupling structure of FIG. 5;

FIG. 9A, FIG. 9B, FIG. 9C, FIG. 9D, FIG. 9E, and FIG. 9F are cut away sides views illustrating an exemplary fabrication process for the optical interconnect system of FIG. 1;

FIG. 10 is a flow chart of an exemplary optical interconnect method in accordance with aspects of the present invention;

FIG. 11A and FIG. 11B are perspective views of an exemplary modulator of an optical interconnect system in accordance with another aspect of the present invention;

FIG. 12 is a perspective view of another exemplary optical interconnect system in accordance with aspects of the present invention;

FIG. 13 is a cut away side view of the optical interconnect system of FIG. 12;

FIG. 14 is an alternative cut away side view of the optical interconnect system of FIG. 12;

FIG. 15 is another alternative cut away side view of the optical interconnect system of FIG. 12;

FIG. 16 is another alternative cut away side view of the optical interconnect system of FIG. 12;

FIG. 17 is an illustrative side view of an exemplary free-space coupling structure of the optical interconnect system of FIG. 12;

FIG. 18A, FIG. 18B, FIG. 18C, FIG. 18D, and FIG. 18E are cut away side views illustrating an exemplary fabrication process for the optical interconnect system of FIG. 12;

FIG. 19 is a flow chart of another exemplary optical interconnect method in accordance with aspects of the present invention;

FIG. 20 is a side view of another exemplary optical interconnect system in accordance with aspects of the present invention; and

FIG. 21 is a flow chart of another exemplary optical interconnect method in accordance with aspects of the present invention.

### DETAILED DESCRIPTION OF THE INVENTION

The exemplary systems and methods disclosed herein may be employed in conjunction with integrated circuit chips. The exemplary systems and methods disclosed herein are suitable to provide a high bandwidth, high coupling efficiency, low power consumption, single layer and easily manufacturable optical interconnect architecture with a very small footprint and silicon complementary metal-oxide-semiconductor (CMOS) compatibility. The small form factor may also provide high optical link density. At 5 gigabits per second (Gbps) per link, the optical interconnection systems and methods described herein may provide an aggregate bandwidth of up to 25 terabits per second (Tbps) or more for the global interconnection fabric for an integrated circuit chip.

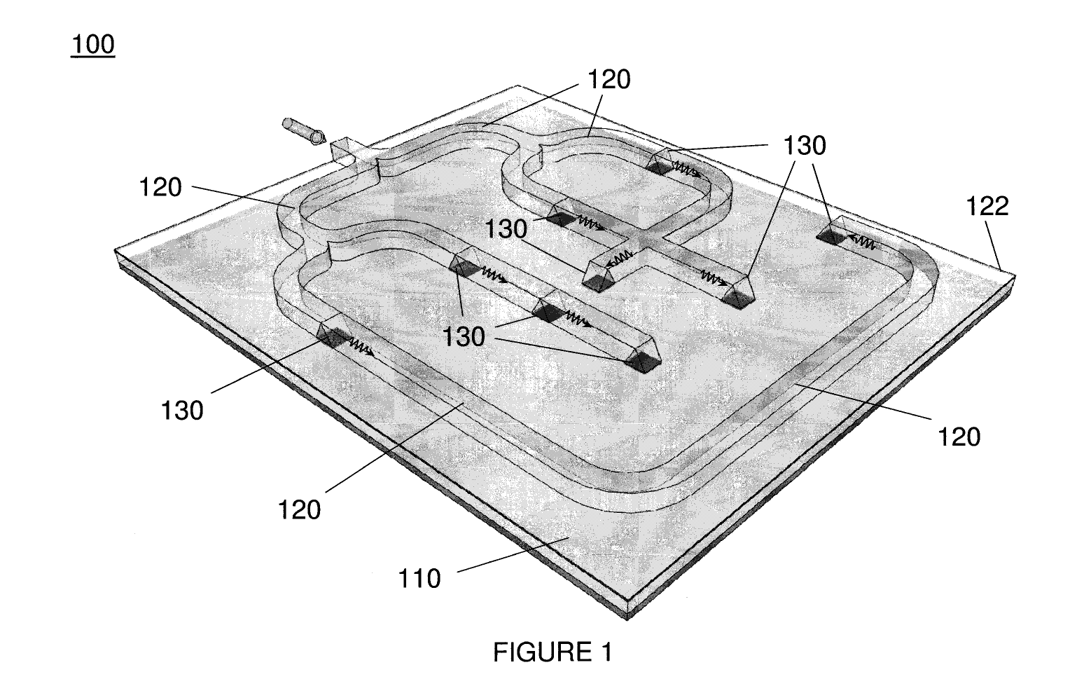

Referring now to the drawings, FIGS. 1-9 illustrate an optical interconnect system 100 in accordance with aspects of the present invention. System 100 may be used in conjunction with an integrated circuit chip. As a general overview, system 100 includes a substrate 110, a wave path (such as waveguide 120), at least one coupling structure 130 (nine depicted), and a modulator 140. Additional details of system 100 are described herein.

Substrate 110 is a base layer of the optical interconnect system 100, as illustrated in FIGS. 1-3. In an exemplary embodiment, substrate 110 is the substrate of an integrated circuit chip. Substrate 110 includes electrical circuitry, e.g., conventional metal interconnections. Substrate 110 may further include one or more metal interconnect layers, and metal vias electrically connecting the one or more metal interconnect layers. Substrate 110 may be a conventional CMOS silicon substrate. Suitable materials for forming substrate 110 will be known to one of ordinary skill in the art from the description herein.

The wave path is a space for the propagation of light. The wave path may desirably be a waveguide 120 disposed on substrate 110, as illustrated in FIGS. 1, 2A, and 3. Alternatively, the wave path for the light may comprise free-space, for example, for use with laser light sources. In an exemplary embodiment, the wave path is a waveguide 120. Waveguide 120 is an optical waveguide that at least partially confines a beam of optical light. While the exemplary systems and methods of the invention are described with respect to optical wavelengths, it will be understood that waveguide 120 may be adapted to confine other wavelengths of light such as electromagnetic radiation outside of the optical spectrum, for example, infrared radiation. Waveguide 120 may be formed above, below, or within a waveguide confining layer 122 formed from a material having a lower refractive index than waveguide 120, in order to confine the light within the waveguide 120. Suitable materials for use as waveguide confining layer 122 include, for example, polymers and SiO₂. Other suitable materials for use as waveguide confining layer 122 will be known to one of ordinary skill in the art from the description herein.

Waveguide 120 may comprise, for example, dielectric waveguides, flexible waveguide films, and/or optical fibers. Materials for waveguide 120 may be chosen in order to minimize the loss of the light (e.g., leakage through the walls of the waveguide into waveguide confining layer 122) during transmission of the light through the waveguide. Waveguide 120 may include multiple channels for the propagation of light. Low loss waveguide crossings and/or turns may be used, as illustrated in FIG. 1.

Suitable materials for forming waveguide 120 include, for example, conventional optical waveguide polymers. Suitable commercially available optical polymer materials will be known to one of ordinary skill in the art from the description herein. Other suitable materials include LiNbO₃, SiO₂, or liquid water. Still other suitable materials for forming waveguide 120 will be understood by one of ordinary skill in the art from the description herein.

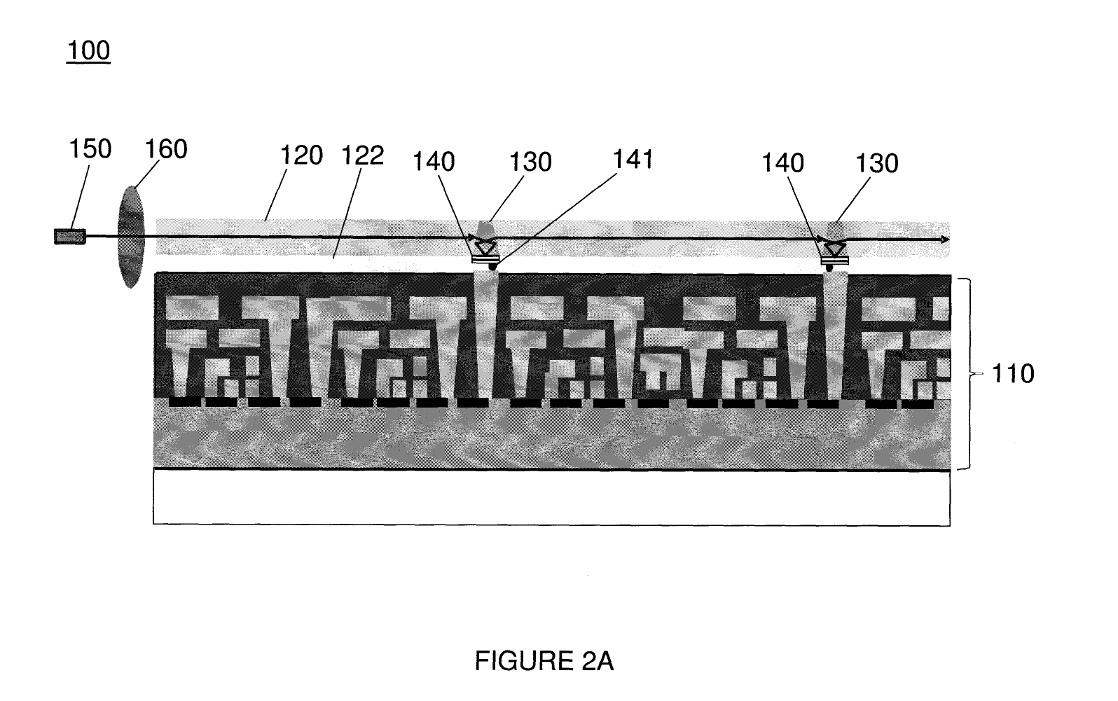

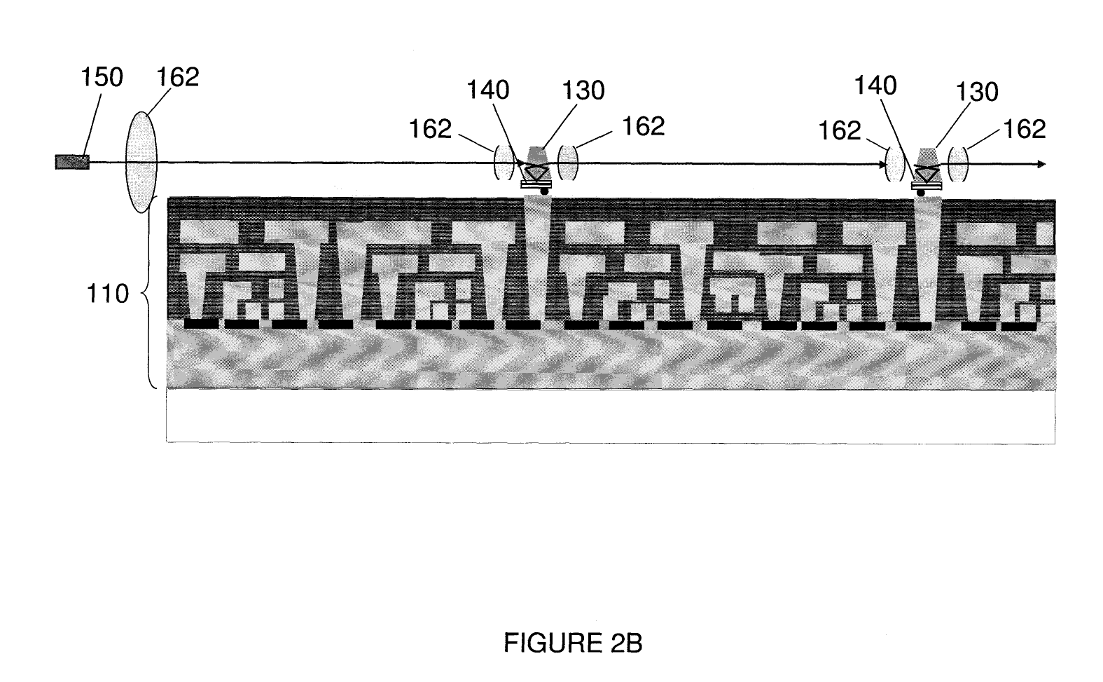

It will be understood that where the wave path for light is free space, no waveguide may be necessary in system 100. In another exemplary embodiment, system 100 may include a free space wave path, as illustrated in FIG. 2B. System 100 having a free space wave path may further include beam steering elements 162. Beam steering elements 162 may steer the light the light source along the wave path, and may further couple the light into and out of coupling structures 130.

Coupling structure 130 is disposed within the wave path, as illustrated in FIGS. 1, 2A, and 3-8. Coupling structure 130 couples light propagating through the wave path onto modulator 140 (FIGS. 2A-8). Coupling structure 130 further couples light reflected from the modulator 140 back into waveguide 120. Coupling structure 130 may comprise any structure adapted to redirect light. Exemplary embodiments of coupling structure 130 are described below.

In one exemplary embodiment, coupling structure 130 is a prismatic structure. The prismatic coupling structure 130 is configured to redirect light transmitted through waveguide 120 onto modulator 140. The prismatic coupling structure 130 is further configured to redirect light reflected from the modulator 140 back into waveguide 120.

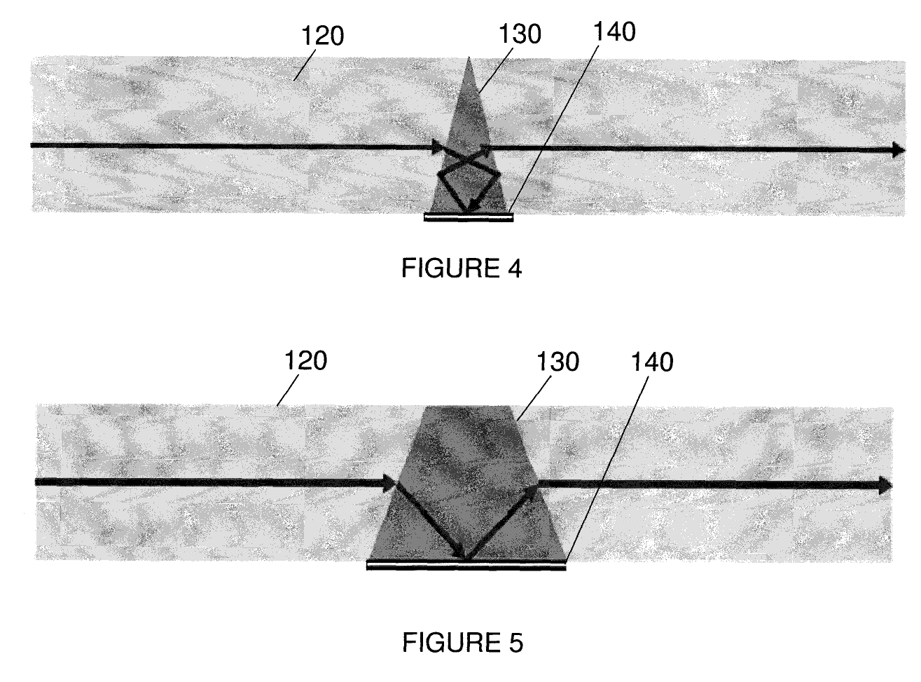

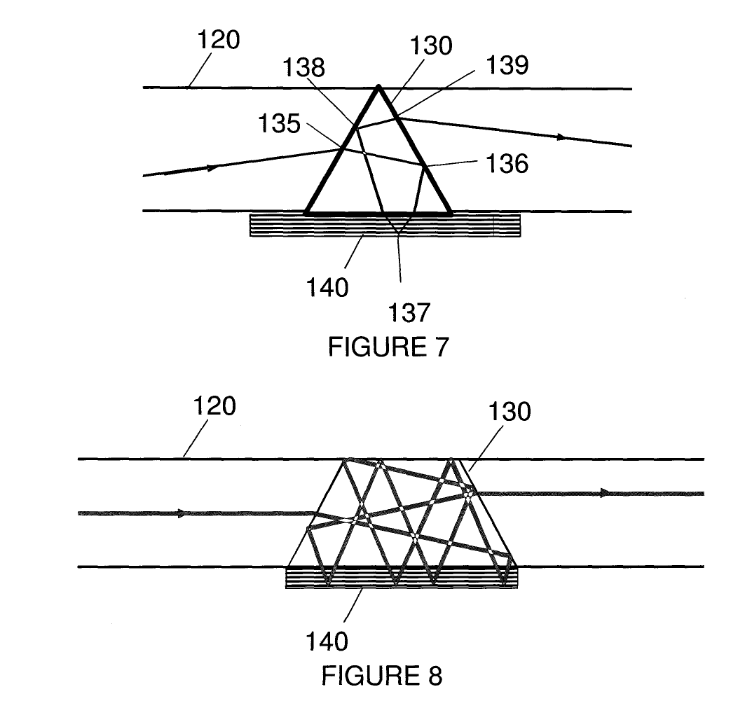

Prismatic coupling structure 130 may be configured to redirect light based on the shape, size, or materials used to form the prism. For example, coupling structure 130 may be a triangle-shaped prism, as shown in FIGS. 4 and 7. Alternatively, coupling structure 130 may be a trapezoid-shaped prism, as shown in FIGS. 5 and 8. The angles and size of the prismatic coupling structure 130 may desirably be chosen to maximize the amount of light in the prism that is reflected or refracted onto the surface of modulator 140. For example, the surface of prismatic coupling structure 130 that is contacted by the beam of light may form an angle of approximately 64° with the surface of substrate 110. Additionally, the materials used to form prismatic coupling structure 130 may desirably be chosen to maximize the amount of light in the prism that is reflected or refracted onto the surface of modulator 140, based on the refractive indices of the waveguide and the prism. Anti-reflection coatings may be formed on facets of the prismatic coupling structure to reduce reflection losses. Prismatic coupling structure 130 may further have curved surfaces for focusing the light entering and exiting the coupling structure. The surfaces may be curved in order to focus or defocus the light entering the coupling structure onto the modulator, and subsequently defocus or focus the light reflected by the modulator back into the wave path.

Materials for prismatic coupling structure 130 may be chosen in order to maintain a minimum contrast of refractive indices between the refractive index of the prism 130 (nₚ) and the refractive index of the waveguide 120 (n_{g}). This is so that the incident light can be efficiently coupled into and out of the bottom plane of the coupling structures, where the light modulator is located. In an exemplary embodiment, the minimum contrast (nₚ/n_{g}) is approximately 1.65. Above this minimum contrast, most of the incoming light beam is coupled to modulator 140 and subsequently out of the prismatic coupling structure and into the output waveguide. Below this contrast, the prismatic coupling structure may still deliver the optical power that is acceptable for the photodetector with partial optical loss; in order to collect most of the incoming light beam, a larger modulator 140, a smaller input spot on the prismatic coupling structure's entrance surface or proper prism configurations may be required. It will also be understood to one of ordinary skill in the art from the description herein that the selection of the materials also depends on the wavelengths of light propagating through waveguide 120, which affects properties of the materials, such as absorption and refractive indices.

Suitable materials for forming prismatic coupling structure 130 include, for example, Si, GaAs, GaP, InP, InAs, Ge, GaSb, AlN, BN, InSb, C, InN, GaN, LiNbO₃, polymers, optical glasses, photoresists, and other optical materials that can meet the desired index contrast between the prismatic structure and the waveguide. Other suitable materials for forming prismatic coupling structures will be understood by one of ordinary skill in the art from the description herein.

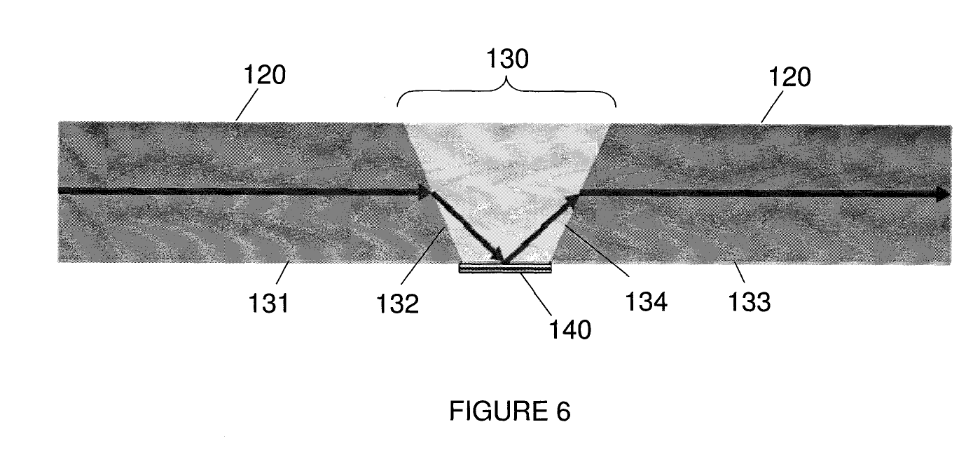

In another exemplary embodiment, coupling structure 130 is a tapered end of waveguide 120, as illustrated in FIG. 6. The coupling structure 130 includes a tapered end 132 of a first portion 131 of waveguide 120 that is configured to redirect light propagating through the first portion of waveguide 120 onto modulator 140. The coupling structure 130 further includes a tapered end 134 of a second portion 133 of waveguide 120 that is configured to redirect light reflected from the modulator 140 into the second portion of waveguide 120. The tapered ends 132 and 134 of the first and second portions 131 and 133 of waveguide 120 may be spaced from each other by a gap. In an exemplary embodiment, the gap is filled with material from waveguide confining layer 122. In an alternative embodiment, the gap may be a void area, or filled with another material.

The tapered ends of coupling structure 130 may be configured to redirect light based on their shape, and based on the materials of waveguide 120. The angles of the tapered ends may desirably be chosen to maximize the amount of light in waveguide 120 that is reflected or refracted onto the surface of modulator 140. For example, when a waveguide with a refractive index of 1.4 is used, a pair of tapered ends with angles of 45 degrees or more may be used with an air gap in the middle to redirect the beam out of the waveguide structure and onto the modulator. Additionally, the materials used to form waveguide 120 may desirably be chosen to maximize the amount of light in the prism that is reflected or refracted onto the surface of modulator 140, based on the refractive indices of the waveguide and the surrounding medium (e.g., the confining layer). For example, the light may be refracted from waveguide 120 onto modulator 140, as illustrated in FIG. 6, when the waveguide material is chosen to have a higher refractive index than the material (e.g., waveguide confining layer material) between the tapered ends 132 and 134. This example may be thought of as the reverse of the prismatic coupling structure discussed above.

Modulator 140 is positioned between substrate 110 and coupling structure 130, as illustrated in FIGS. 2A-8. In an exemplary embodiment, modulator 140 is a multiple quantum well modulator. Modulator 140 may be mounted to substrate 110, for example, by flip-chip bonding (illustrated by bond elements such as bond element 141 in FIG. 2). For flip-chip bonding, a photonic layer may be formed to replace conventional metallization layers for chip-scale interconnections. Modulator 140 may be positioned beneath coupling structure 130 in order to receive light redirected by coupling structure 130. Modulator 140 is configured to modulate the light received from coupling structure 130. For example, modulator 140 may be configured to encode a stream of data into the light propagating through waveguide 120, as will be described in further detail below.

Modulator 140 is interconnected with the electrical circuitry in substrate 110, e.g., by normal metal wire interconnects. Modulator 140 may include bump bonds for electrically connecting the modulator to the electrical circuitry. The electrical circuitry in substrate 110 may be configured to control modulator 140 by applying a bias voltage to modulator 140. For example, the circuitry may control modulator 140 to modulate the light received in order to encode a stream of data into the light propagating through waveguide 120. Thus, the encoding of data into the light may be controlled by the circuitry in substrate 110, as will be described herein.

While modulator 140 is described above as a multiple quantum well modulator, modulator 140 is not so limited. Modulator 140 may comprise, for example, an electro-absorption modulator (such as a multiple quantum well modulator), an electro-optic modulator, an acousto-optic modulator, or a thermo-optic modulator. For short-distance optical interconnects (such as on-chip and chip-to-chip communications), modulator 140 may comprise a vertical-cavity surface-emitting laser (VCSEL) or a light modulator. VCSELs may be particularly suitable for long distance high-power applications. Modulator 140 may also comprise, for example, other surface-normal modulators. Surface-normal optical modulators may be desirable for use in dense 2-D arrays of devices integrated with silicon CMOS circuitry.

System 100 may include one or more modulators 140 disposed beneath respective coupling structures 130. Where system 100 includes more than one modulator 140/coupling structure 130 pair, the multiple pairs may be positioned in series along one channel of waveguide 120, and/or may be positioned in parallel along multiple different channels of waveguide 120.

It will be understood that optical interconnect system 100 is not limited to the above components, but may include alternative components and additional components, as would be understood by one of ordinary skill in the art from the description herein.

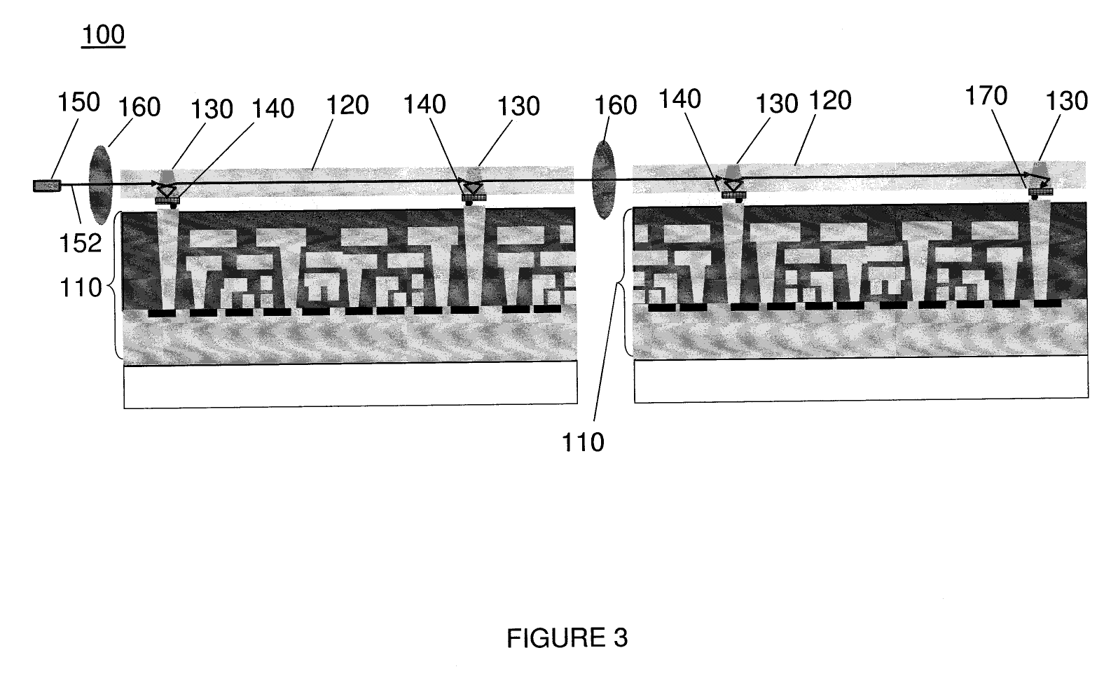

Optical interconnect system 100 may include a light source 150, as illustrated in FIGS. 2A, 2B, and 3. Light source 150 provides the light that propagates through waveguide 120. In an exemplary embodiment, light source 150 is an external continuous wave (CW) laser. Suitable lasers for use as light source 150 include, for example, vertical-cavity surface-emitting lasers (VCSELs) and distributed feedback (DFB) lasers. Alternatively, light source 150 may be an LED. Other suitable light sources 150 for use with the present invention will be understood to one of ordinary skill in the art from the description herein.

Optical interconnect system 100 may further include an input coupling system 160, as illustrated in FIGS. 2A and 3. Input coupling system 160 couples light from light source 150 into waveguide 120, for propagation through the waveguide. Input coupling system 160 may also couple light between multiple waveguides 120 on different substrates 110, as illustrated in FIG. 3. In an exemplary embodiment, input coupling system 160 may comprise one or more lenses (not shown). Lenses may be positioned at an end of waveguide 120. Suitable lenses for use as input coupling system 160 will be known to one of ordinary skill in the art from the description herein. Other input coupling systems include, for example, taper-ended waveguides, lenses integrated with the light source, and gratings. Additionally, it will be understood that the light from light source 150 may be directly coupled into waveguide 120 (e.g., for light sources integrated on substrate 110). In these circumstances, input coupling system 160 may be excluded.

Optical interconnect system 100 may further include beam steering elements 162, as illustrated in FIG. 2B. As described above, beam steering elements 162 steer the light when the wave path comprises free space. Beam steering elements 162 may further be positioned to couple light into and out of coupling structures 130. Suitable beam steering elements 162 include prisms, lenses, mirrors, and/or gratings.

Optical interconnect system 100 may further include a photodetector 170, as illustrated in FIG. 3. Photodetector 170 may be positioned between substrate 110 and waveguide 120. System 100 may include another coupling structure 130 disposed above photodetector 170, configured to redirect the light from the waveguide onto photodetector 170. In an exemplary embodiment, photodetector 170 is a multiple quantum well modulator, substantially as described above with respect to modulator 140. Photodetector 170 is interconnected with the electrical circuitry in substrate 110. Photodetector 170 receives modulated light from waveguide 120, and is configured to output a data stream encoded in the modulated light to the electrical circuitry.

The operation of optical interconnect system 100 will now be described with reference to FIG. 3. A light source 150 is configured to provide a light beam 152 that propagates through waveguide 120. The light contacts coupling structure 130, and is redirected onto modulator 140. Modulator 140 modulates the light it receives by selectively reflecting and absorbing the light. For example, in a first mode, modulator 140 is configured to reflect the light directed onto it by coupling structure 130. In the first mode, modulator 140 may reflect substantially all of the light back into the waveguide 120, by way of coupling structure 130. In a second mode, modulator 140 is configured to reflect less than all of the light directed onto it by coupling structure 130. Modulator 140 may reflect substantially no light back into waveguide 120, or may reflect only a portion of the light back into waveguide 120. In this way, modulator 140 may be switched between modes in order to encode a stream of data into the light propagating through waveguide 120, by selectively reflecting or absorbing the light redirected onto the modulator by coupling structure 130. The light reflected by modulator 140 is redirected back into waveguide 120 by coupling structure 130. This modulation may be repeated by additional pairs of coupling structures 130 and modulators 140. The light continues to propagate through waveguide 120 until it is redirected by a coupling structure 130 onto photodetector 170. The data encoded into the light by modulator(s) 140 is then decoded, and output to the electrical circuitry by photodetector 170.

The redirection of light in an exemplary triangle-shaped prismatic coupling structure 130 is described herein with reference to FIG. 7. In FIG. 7, an arbitrary light ray within the waveguide's ray bundle is depicted to show the coupling mechanism. In the exemplary coupling structure, the light ray is refracted into the prism at point 135, and then reflected by total internal reflection (TIR) twice on the prism's inner surfaces at points 136 and 138 before exiting the coupling structure. Upon the first TIR at point 136, the beam is reflected downwards toward exemplary modulator 140, where it is either absorbed or reflected at point 137 during the propagation depending on the bias applied to modulator 140 through the underlying CMOS circuitry. The reflected light is re-directed inside the prism by TIR again at point 138 and then guided back into waveguide 120 via refraction at point 139. It will be understood to one of ordinary skill in the art from the description herein that the above-described refractions and reflections will be dependent on at least the refractive index of the waveguide, the refractive index of the prismatic coupling structure, the refractive index of the modulator, the refractive indices of the upper and lower confining layers, and the size and shape of the prismatic coupling structure.

The redirection of light in an exemplary trapezoid-shaped prismatic coupling structure 130 is depicted in FIG. 8. In a trapezoid-shaped prism, as opposed to a triangle-shaped prism, multiple incidences and reflections on the modulator are allowed, as compared to the single incidence with the triangle-shaped prism (illustrated in FIG. 7). Thus, a trapezoid-shaped prism may increase the opportunity for the photons to interact with modulator 140, and therefore enhance the modulation depth of the coupling structure 130/modulator 140 pair. Alternatively, a trapezoid-shaped prism may be structured to allow only a single reflection of the light beam by the modulator, as shown in FIG. 5. The illustrated trapezoid-shaped prism may necessitate an additional reflective coating on the top surface of the prism.

It will be understood that while triangle-shaped and trapezoid shaped prisms are illustrated and described herein, prismatic coupling structure 130 may have other shapes. Thereby, prismatic coupling structure 130 may cause essentially any number of internal reflections and refractions to redirect light onto modulator 140.

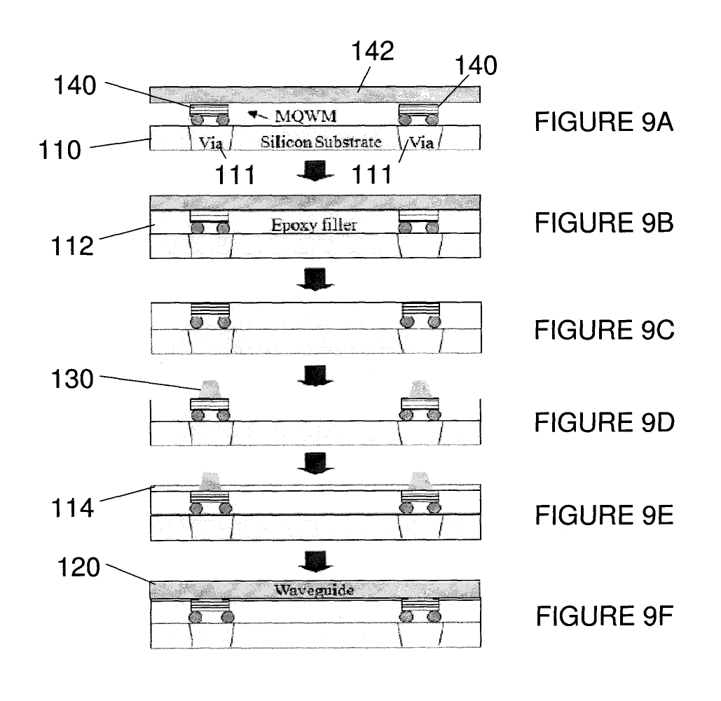

The fabrication of an exemplary embodiment of optical interconnect system 100 will now be described. As illustrated in FIG. 9A, modulators 140 are attached to substrate 110. Modulators 140 may be attached to substrate 110 by flip-chip bonding. For example, substrate 110 may include a number of vias 111 for enabling metallic interconnects. Modulators 140 may be disposed on a modulator substrate 142 in locations corresponding to the vias 111 in substrate 110. Modulator substrate 142 and substrate 110 can be disposed adjacent one another in order to bond modulators 140 onto substrate 110. As illustrated in FIG. 9B, an epoxy layer 112 is flowed between the substrate 110 and modulator substrate 142. Suitable epoxy for epoxy layer 112 includes, for example, polyoxyalkyleneamine. In some cases, this epoxy layer may be directly used as the confining layer 122 (or cladding layer) below the waveguide layer, as shown in FIGS. 1-3, without an additional cladding layer 114. Then, as illustrated in FIG. 9C, modulator substrate 142 is removed. The modulator substrate 142 may be removed by a conventional etch-removal process.

As illustrated in FIG. 9D, prismatic coupling structures 130 are formed on top of modulators 140. The prismatic coupling structures 130 may be fabricated using gray scale lithography and inductively-coupled plasma (ICP) etching. Alternatively, the prismatic coupling structures 130 may be fabricated from chalcogenide glass. As illustrated in FIG. 9E, a cladding layer 114 may be formed on top of the epoxy layer around prismatic coupling structures 130. The cladding layer may be spun-on in a conventional manner. Finally, as illustrated in FIG. 9F, the waveguide 120 is fabricated around prismatic coupling structures 130, such that the prismatic coupling structures are embedded in the waveguides. The waveguide 120 may also be spun-on in a conventional manner. It will be understood that the above fabrication steps provide only an example for the fabrication of optical interconnect system 100. Additional or alternative steps than those described above will be understood by one of ordinary skill in the art from the description herein.

To form embodiments of optical interconnect system 100 having coupling structure 130 comprising tapered ends, the fabrication steps described below with respect to optical interconnect system 300 may be used. Further, the above fabrication steps may be used to fabricate embodiments of optical interconnect system 300 having prismatic free-space coupling structures 330, which will be later described.

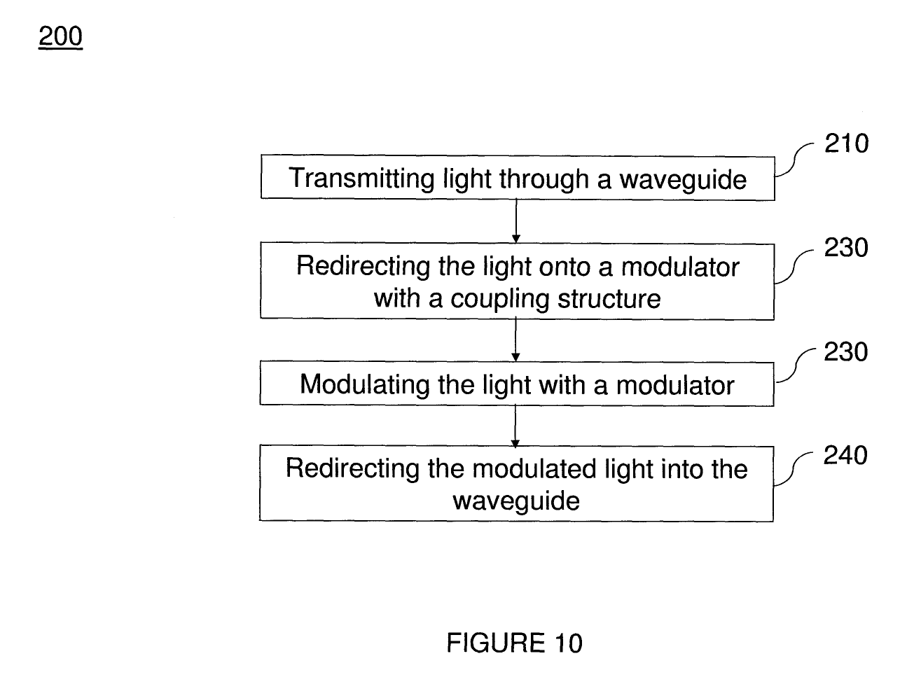

FIG. 10 is a flow chart depicting an exemplary optical interconnect method 200 in accordance with aspects of the present invention. Method 200 may be performed with an integrated circuit chip. As a general overview, method 200 includes transmitting light, redirecting light onto a modulator, modulating the light, and redirecting the modulated light. To facilitate description, the steps of method 200 are described herein with reference to the components of system 100.

In step 210, light is transmitted through a wave path. In an exemplary embodiment, light is transmitted through waveguide 120. The light may be provided by a light source such as light source 150. Light from light source 150 may be coupled into waveguide 120 by input coupling system 160.

In step 220, the light is redirected onto a modulator with a coupling structure. In an exemplary embodiment, coupling structure 130 redirects the light onto a modulator 140. Coupling structure 130 may be positioned in waveguide 120 on top of a modulator 140. Coupling structure 130 may comprise a prism shaped to reflect or refract the light onto the modulator 140. Alternatively, coupling structure 130 may comprise ends of waveguide 120 shaped to reflect or refract the light onto the modulator 140.

In step 230, the light from the coupling structure is modulated with the modulator. In an exemplary embodiment, modulator 140 modulates the light. Modulator 140 may selectively reflect or absorb the light in order to encode a stream of data into the light. Modulator 140 may be interconnected with electrical circuitry within the substrate 110 that controls the switching of modulator 140.

In step 240, the modulated light is redirected into the wave path. In an exemplary embodiment, light reflected by modulator 140 is redirected into waveguide 120 by coupling structure 130. Coupling structure 130 may reflect or refract the light back into waveguide 120, as described above.

It will be understood that optical interconnect method 200 is not limited to the above steps, but may include additional steps, as would be understood by one of ordinary skill in the art from the description herein.

The modulated light may further be redirected onto a photodetector with another coupling structure. In an exemplary embodiment, another coupling structure 130 redirects the modulated light from the waveguide 120 onto photodetector 170. Other types of couplers, such as reflective facets, may also be used to redirect the modulated light onto the photodetector. Photodetector 170 then receives the modulated light. The data encoded into the light by modulator(s) 140 is then decoded, and output to electrical circuitry within the substrate 110 by photodetector 170.

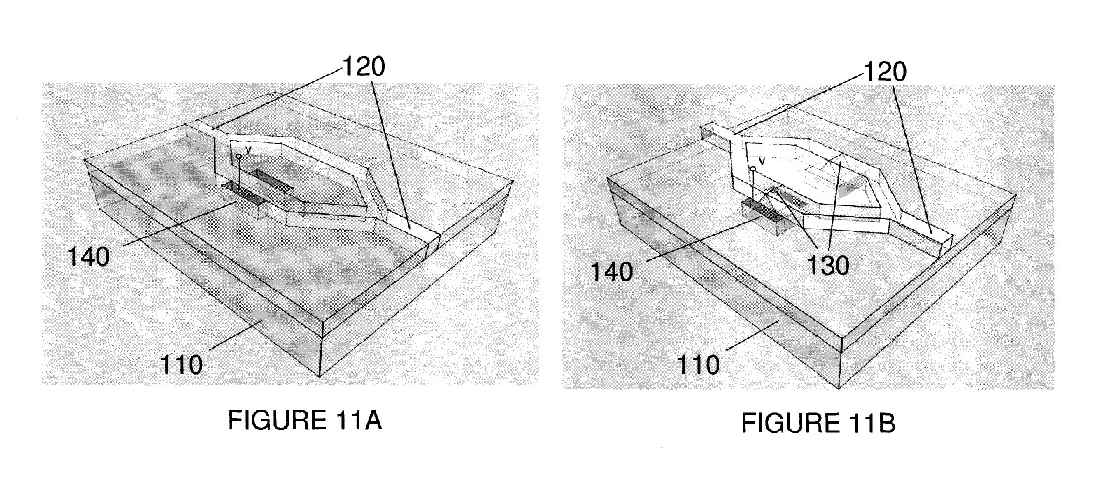

In another aspect of the present invention, coupling structures 130 and modulators 140 may be replaced by waveguide modulators 140A (planar waveguide and channel waveguide(s), e.g., Mach-Zehnder type modulators). In an exemplary embodiment, modulator 140A is a Mach-Zehnder type modulator, as illustrated in FIG. 11A. Mach-Zehnder type modulators operate by varying the path length of two separated equal beams, thereby creating interference. At the location of modulator 140A, waveguide 120 splits into two even paths, with one path including Mach-Zehnder modulator 140A. As the beam of light propagates through waveguide 120, it separates into two equal beams, which propagate through a respective path. Mach-Zehnder modulator 140A is disposed in the same plane as waveguide 120, on either side of one of the paths of waveguide 120. Mach-Zehnder modulator 140A changes the phase of one of the separated beams using an electric field. When the beams are recombined, the beams are out of phase with each other, interference is created. This structure functions in an interferometric manner: by changing the applied voltage, the phase of the separated incoming light beams may be altered and become in-phase or out-of-phase when the light beams are recombine at the output. It will be understood that when modulator 140A is a Mach-Zehnder modulator, prismatic coupling structures 130 may be unnecessary. Nonetheless, as illustrated in FIG. 11B, a prismatic coupling structure 130 can be combined with the Mach-Zehnder structure. Other suitable waveguide modulators 140A will be known to one of ordinary skill in the art from the description herein.

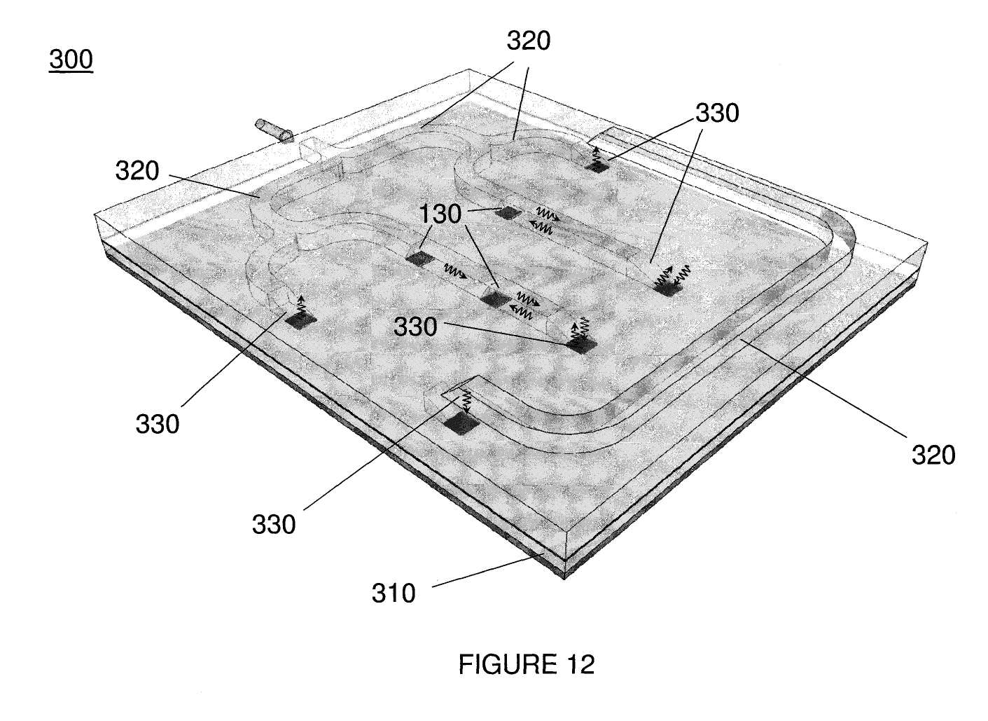

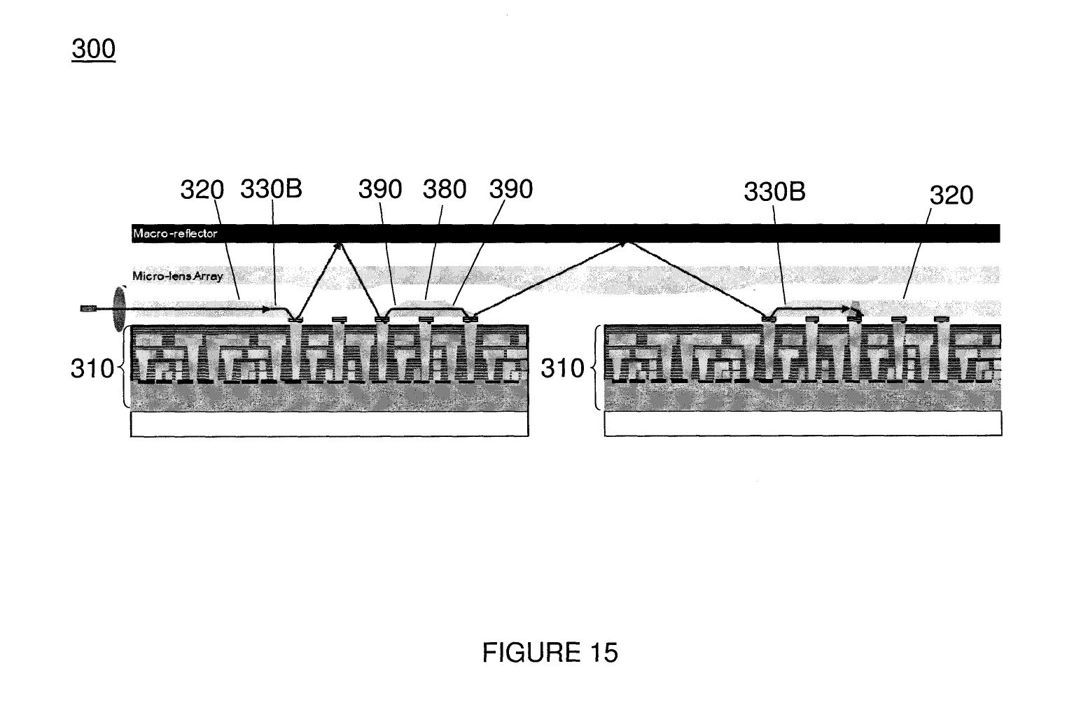

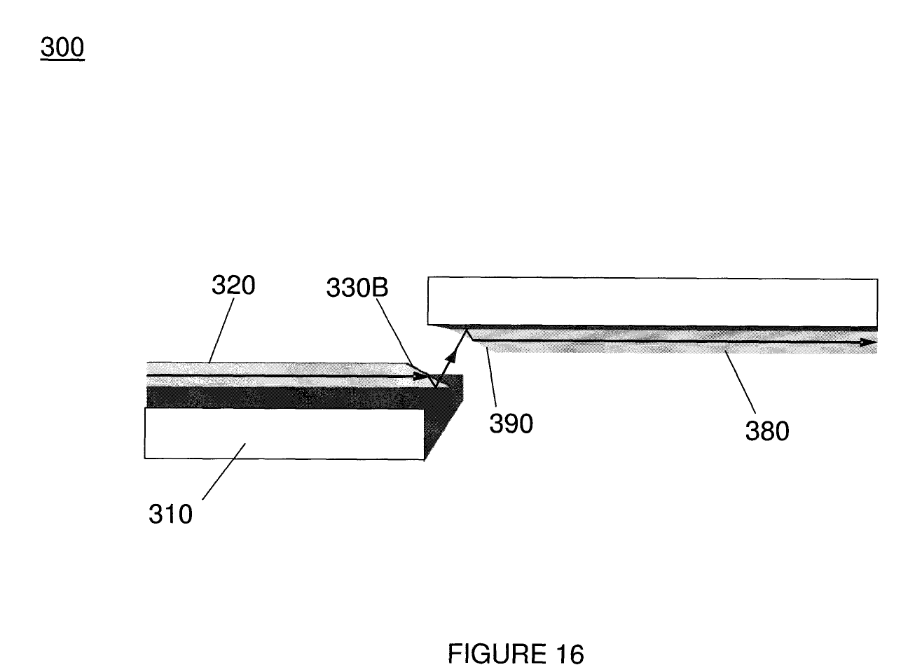

FIGS. 12-17 illustrate another optical interconnect system 300 in accordance with aspects of the present invention. System 300 may be used in conjunction with an integrated circuit chip. System 300 may be implemented by itself or in combination with system 100. As a general overview, system 300 includes a substrate 310, a waveguide 320, and a free-space coupling structure 330. Additional details of system 300 are described herein.

Substrate 310 is a base layer of optical interconnect system 300, as illustrated in FIGS. 12-16. In an exemplary embodiment, substrate 310 is the substrate of an integrated circuit chip, substantially as described above with respect to substrate 110.

Waveguide 320 is disposed on substrate 310, as illustrated in FIGS. 12-16. In an exemplary embodiment, waveguide 320 is an optical waveguide that at least partially confines a beam of optical light, substantially as described above with respect to waveguide 120. As set forth above, while the exemplary systems and methods of the invention are described with respect to optical wavelengths, it will be understood that waveguide 320 may be adapted to confine other wavelengths of light such as electromagnetic radiation outside of the optical spectrum, for example, infrared radiation. Waveguide 320 may be formed on or within a waveguide confining layer 322 formed from a material having a lower refractive index than waveguide 320, in order to confine the light within the waveguide 320. Suitable materials for use as waveguide confining layer 322 include those materials listed above with respect to waveguide confining layer 122.

Free-space coupling structure 330 is adjacent waveguide 320, as illustrated in FIGS. 12-17. Free-space coupling structure 330 redirects light out of the first waveguide 320. As used herein, free space refers to a space where the movement of energy in any direction is substantially unimpeded, or an area lacking a waveguide adapted to confine the direction of propagation of a beam of light. For example, free-space could be air, or could be some material (e.g. waveguide confining layer) outside of the waveguide. Free-space coupling structure 330 may comprise any structure adapted to redirect light into free space. Exemplary embodiments of free-space coupling structure 330 are described herein.

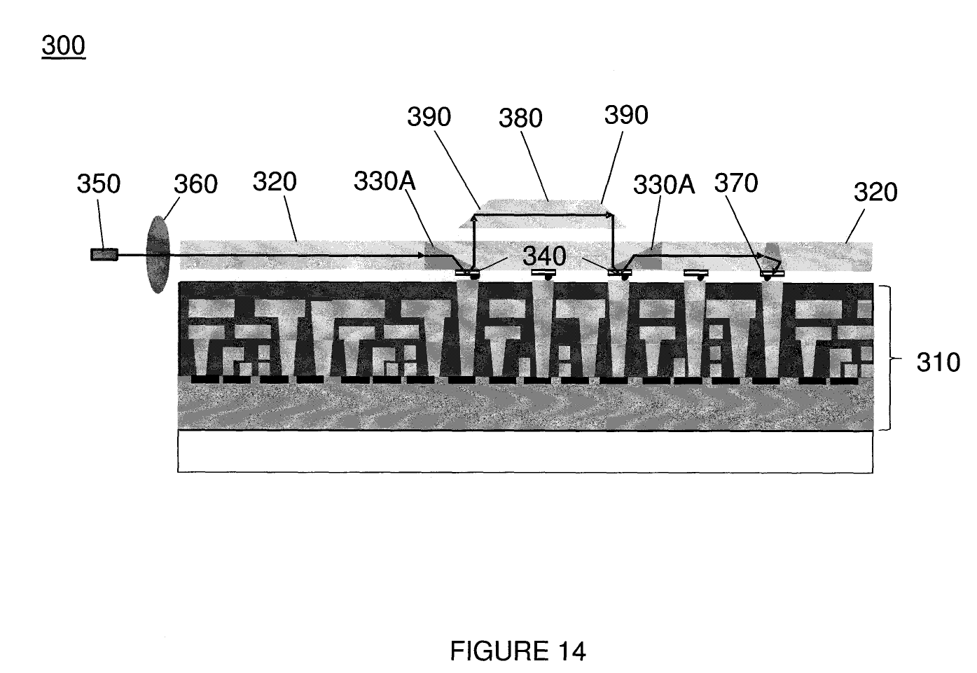

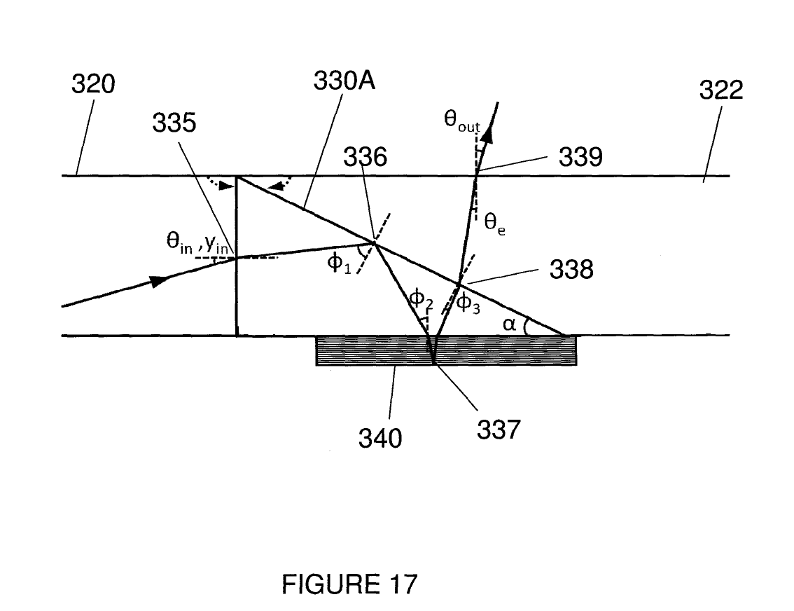

In one exemplary embodiment, free-space coupling structure 330 is a prismatic structure 330A embedded within waveguide 320 (as illustrated in FIGS. 14 and 17), substantially as described above with reference to coupling structure 130. Prismatic free-space coupling structure 330A may be configured to redirect light out of waveguide 320 based on the shape, size, or materials used to form the prism.

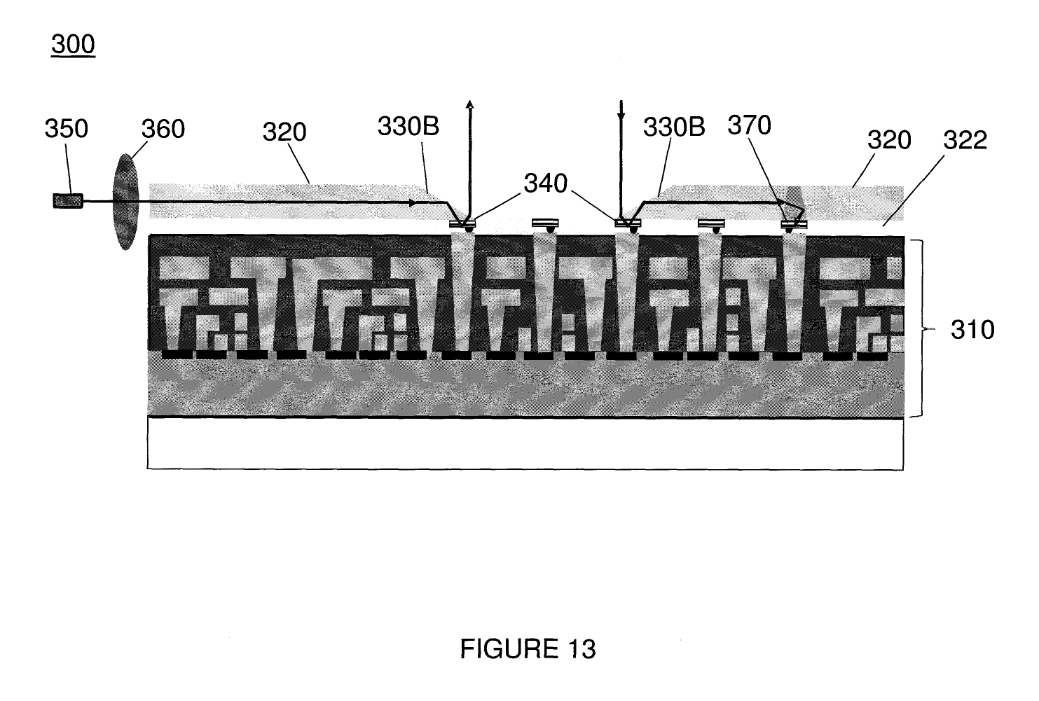

In another exemplary embodiment, free-space coupling structure 330 is an end surface 330B of waveguide 320 (as illustrated in FIGS. 13, 15, and 16). The end surface 330B of waveguide 320 is angled with respect to a perpendicular cross-section of waveguide 320. The angled end of coupling structure 330B may be configured to redirect light out of waveguide 320 based on its shape, and based on the materials of waveguide 320.

It will be understood that optical interconnect system 300 is not limited to the above components, but may include additional components, as would be understood by one of ordinary skill in the art from the description herein.

Optical interconnect system 300 may include one or more coupling structures 130, as illustrated in FIG. 12. Coupling structures 130 may redirect light onto modulators (not shown), as described above with respect to system 100.

Optical interconnect system 300 may include a reflective element 340 positioned between substrate 310 and free-space coupling structure 330, as illustrated in FIGS. 13, 14, and 17. In an exemplary embodiment, reflective element 340 is a reflective surface. Suitable materials for forming the reflective surface include, for example, micromirrors. The reflection at reflective element 340 may also be realized by total internal reflection (TIR) between free-space coupling structure 330 and substrate 310 or waveguide confining layer 322. Other suitable reflective materials will be understood by one of ordinary skill in the art from the description herein. In an alternative exemplary embodiment, reflective element 340 is a modulator such as a multiple quantum well modulator, substantially as described above with respect to modulator 140. Modulator reflective element 340 may be configured to selectively reflect or absorb the light in order to encode a stream of data into the light being redirected out of the waveguide, as described above.

Optical interconnect system 300 may include a light source 350, as illustrated in FIGS. 13 and 14. Light source 350 provides the light that propagates through waveguide 320. In an exemplary embodiment, light source 350 is a continuous wave laser, substantially as described above with respect to light source 150.

Optical interconnect system 300 may further include an input coupling system 360, as illustrated in FIGS. 13 and 14. Input coupling system 360 couples light from light source 350 into waveguide 320, for propagation through the waveguide. In an exemplary embodiment, input coupling system 360 may comprise one or more lenses (not shown), substantially as described above with respect to input coupling system 160.

Optical interconnect system 300 may further include a second waveguide 380, as illustrated in FIGS. 14-16. In an exemplary embodiment, second waveguide 380 may be an optical waveguide adapted to confine a beam of light, substantially as described above with respect to waveguide 120. Waveguide 380 is positioned to receive the light redirected out of waveguide 320. For example, first waveguide 320 may be positioned in a first plane substantially parallel with a surface of substrate 310, and second waveguide 380 may be positioned in a second plane substantially parallel with the surface of substrate 310. The second plane may be vertically spaced from the first plane.

Optical interconnect system 300 may further include another free-space coupling structure 390 disposed in waveguide 380, as illustrated in FIGS. 14-16. Free-space coupling structure 390 couples light redirected out of waveguide 320 into waveguide 380. Free-space coupling structure 390 may be a structure substantially as described with respect to free-space coupling structure 330. The free-space coupling structure 330 of the first waveguide 320 may be positioned directly above or below the free-space coupling structure 390 of the second waveguide 380, as illustrated in FIG. 14.

Optical interconnect system 300 may further include free-space optical elements. Free-space optical elements may redirect the light from waveguide 320 in order to help couple light redirected out of waveguide 320 to waveguide 380, or other suitable destinations. In an exemplary embodiment, free-space optical elements include one or more flat or curved mirrors, lenses, gratings, or other redirecting or coupling elements. Other suitable free-space optical elements will be understood by one of ordinary skill in the art from the description herein.

The operation of optical interconnect system 300 will now be described. A light source 350 is configured to provide a light that propagates through waveguide 320. The light propagates through waveguide 320 in a first direction. The first direction may be substantially parallel with the surface of substrate 310. The light contacts free-space coupling structure 330, and is redirected out of waveguide 320 in a second direction. The second direction may or may not be different from the first direction. The second direction may be normal to the surface of substrate 310. Other directions may also be achieved by properly configuring free-space coupling structure 330. It will be understood that free-space coupling structure 330 may also be configured to achieve free-space emission of the light beam parallel with substrate 310. This configuration may be useful when the coupling structure is used as beam steering element in free-space optical communications. Free-space coupling structure 330 may be configured such that substantially all of the light contacting free-space coupling structure 330 is redirected out of waveguide 320. The light redirected out of waveguide 320 may be coupled into a second waveguide 380. Waveguide 380 may include another free-space coupling structure 390 for coupling the light into waveguide 380. The light may then propagate through waveguide 380.

The redirection of light in an exemplary free-space coupling structure 330 is described herein with reference to FIG. 17. In FIG. 17, an arbitrary light ray within the waveguide's ray bundle is depicted to show the coupling mechanism. Where the exemplary coupling structure is a prism, the light ray is refracted into the prism at point 335. Where the exemplary coupling structure merely comprises a tapered end of waveguide 320, there will be no refraction at point 335, because there will be no interface between a prism and the waveguide. The light is then reflected by total internal reflection (TIR) once on the coupling structure's inner surface at point 336 before exiting the coupling structure. Upon the TIR at point 336, the beam is reflected downwards toward reflective element 340, where it is reflected at point 337. Alternatively, where reflective element 340 is a modulator, the light may be reflected or absorbed during the propagation depending on the bias applied to modulator 340 through the underlying CMOS circuitry. The reflected light is then redirected out of waveguide 320 via refraction at point 338. Where a confining layer 322 is positioned adjacent free-space coupling structure 330, the light redirected out of waveguide 320 may further be refracted again at point 339, where the light leaves the confining layer 322. It will be understood to one of ordinary skill in the art from the description herein that the above-described refractions and reflections will be dependent on at least the refractive index of the waveguide, the refractive index of the prismatic coupling structure (if used), the refractive index of the modulator (if used), the refractive indices of the upper and lower confining layers, and the size and shape of the free-space coupling structure.

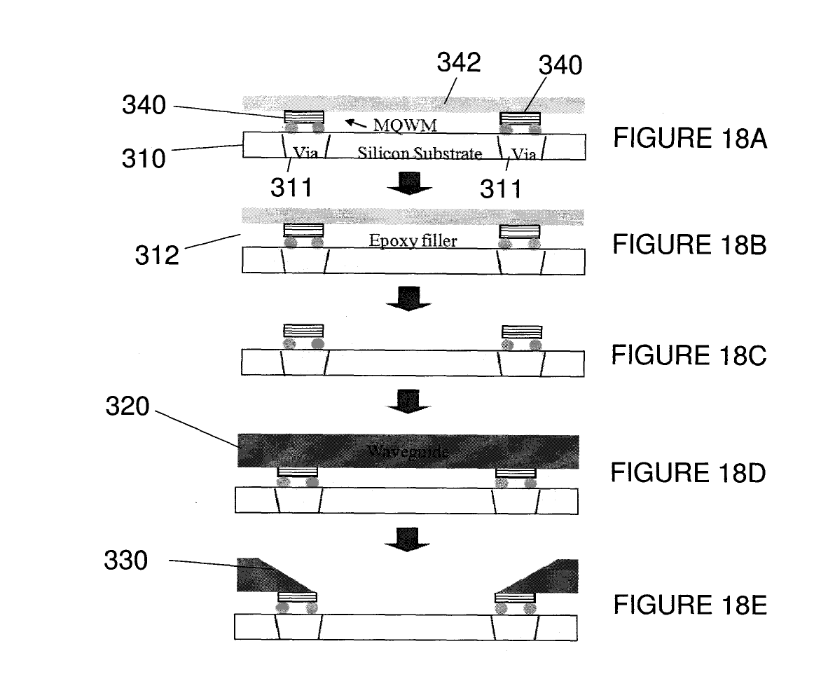

The fabrication of an exemplary embodiment of optical interconnect system 300 will now be described. As illustrated in FIG. 18A, reflective elements such as modulators 340 are attached to substrate 310. Modulators 340 may be attached to substrate 310 by flip-chip bonding. For example, substrate 310 may include a number of vias 311 for enabling metallic interconnects. Modulators 340 may be disposed on a modulator substrate 342 in locations corresponding to the vias 311 in substrate 310. Modulator substrate 342 and substrate 310 can be disposed adjacent one another in order to bond modulators 340 onto substrate 310. As illustrated in FIG. 18B, an epoxy layer 312 is flowed between the substrate 310 and modulator substrate 342. Suitable epoxy for epoxy layer 312 includes, for example, polyoxyalkyleneamine. Then, as illustrated in FIG. 18C, modulator substrate 342 is removed. The modulator substrate 342 may be removed by an etch-removal process.

As illustrated in FIG. 18D, the waveguide 320 is fabricated on the reflective elements 340 and epoxy layer. The waveguide 320 may be spun on. Then, as illustrated in FIG. 18E, the waveguide 320 is patterned to form free-space coupling structures 330. Free-space coupling structures 330 may be formed by photo-patterning, by etching, or by laser-ablation. It will be understood that the above fabrication steps provide only an example for the fabrication of optical interconnect system 300. Additional or alternative steps than those described above will be understood by one of ordinary skill in the art from the description herein.

To form an optical interconnect system with a prismatic free-space coupling structure 330, the fabrication steps described with respect to system 100 may be used. Further, the above fabrication steps may be used to fabricate certain embodiments of optical interconnect system 100, which was earlier described.

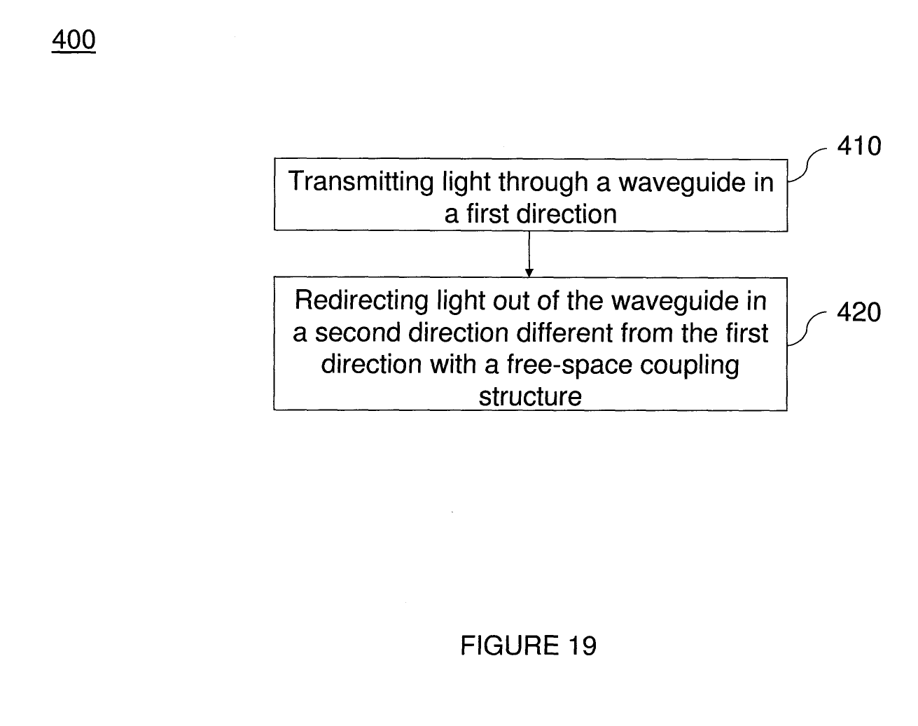

FIG. 19 illustrates a flow chart depicting an exemplary optical interconnect method 400 in accordance with aspects of the present invention. Method 400 may be performed with an integrated circuit chip. Method 400 may be performed by itself or in conjunction with method 200. As a general overview, method 400 includes transmitting light through a waveguide and redirecting the light out of the waveguide. To facilitate description, the steps of method 400 are described herein with reference to the components of system 300.

In step 410, light is transmitted through a waveguide. In an exemplary embodiment, light is transmitted through waveguide 320. The light propagates through waveguide 320 in a first direction. The first direction may be substantially parallel to a surface of substrate 310. The light may be provided by a light source such as light source 350. Light from light source 350 may be coupled into waveguide 320 by input coupling system 360.

In step 420, the light is redirected out of the waveguide. In an exemplary embodiment, light contacting free-space coupling structure 330 is redirected out of waveguide 320 in a second direction. The second direction may be substantially normal to the surface of substrate 310. Substantially all of the light contacting free-space coupling structure 330 may be redirected out of waveguide 320.

It will be understood that optical interconnect method 400 is not limited to the above steps, but may include additional steps, as would be understood by one of ordinary skill in the art from the description herein.

The light redirected out of the first waveguide may further be coupled into a second waveguide. In an exemplary embodiment, light redirected out of waveguide 320 is coupled into waveguide 380. Second waveguide 380 may include another free-space coupling structure 390. Light redirected out of waveguide 320 may be coupled into waveguide 380 with free-space coupling structure 390. Other redirecting or coupling elements, such as mirrors, lenses, or gratings, may also be used. Second waveguide 380 may also be spaced from first waveguide 320. For example, first waveguide 320 may be positioned in a first plane substantially parallel with a surface of substrate 310, while second waveguide 380 is positioned in a second plane substantially parallel with the surface of substrate 310 and spaced from the first plane.

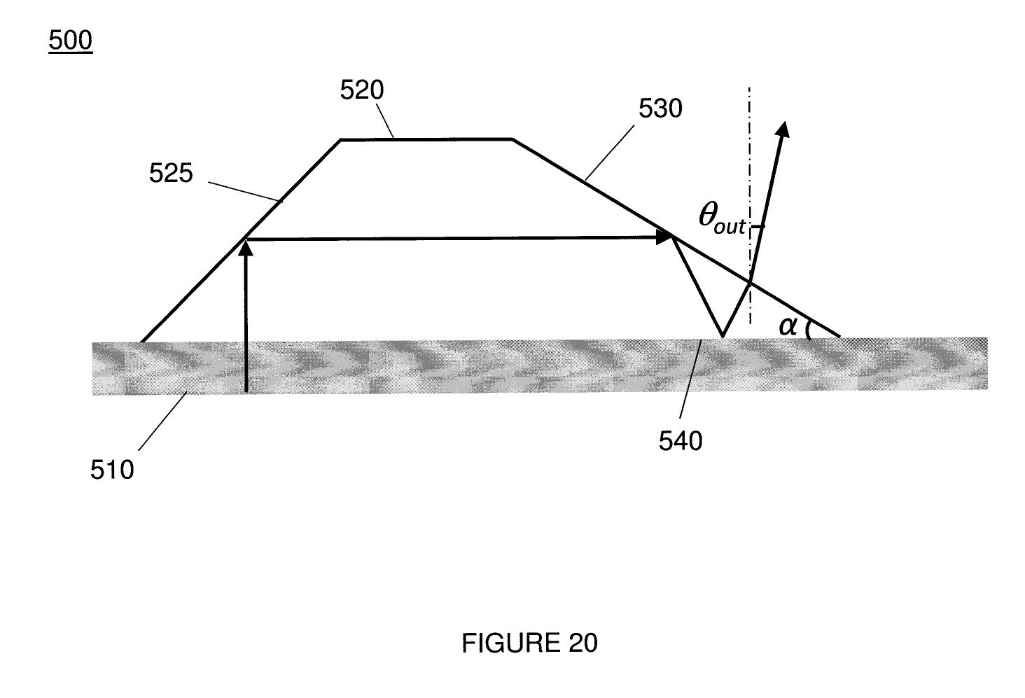

FIG. 20 illustrates another optical interconnect system 500 in accordance with aspects of the present invention. System 500 may be used in conjunction with an integrated circuit chip. System 500 may be implemented by itself or in combination with systems 100 and/or 300. As a general overview, system 500 includes a substrate 510, a waveguide 520, a light-redirecting element 525, and a free-space coupling structure 530. Additional details of system 500 are described herein.

Substrate 510 is a base layer of optical interconnect system 500, as illustrated in FIG. 20. In an exemplary embodiment, substrate 510 is the substrate of an integrated circuit chip, substantially as described above with respect to substrate 110. Substrate 510 may include a light source directly integrated into the substrate, as will be described herein.

Waveguide 520 is disposed on substrate 510, as illustrated in FIG. 20. In an exemplary embodiment, waveguide 520 is an optical waveguide that at least partially confines a beam of optical light, substantially as described above with respect to waveguide 120.

Light-redirecting element 525 is adjacent waveguide 520, as illustrated in FIG. 20. Light-redirecting element 525 redirects light from the light source into the waveguide 520. In an exemplary embodiment, light-redirecting element 525 may comprise a tapered end of waveguide 520. The tapered end may include a reflective coating so that substantially all of the light from a light source is redirected into waveguide 520 by total internal reflection (TIR). Light-redirecting element 525 may form a 45 degree angle in order to redirect light into a direction of propagation through waveguide 520.

Free-space coupling structure 530 is also adjacent waveguide 320, as illustrated in FIG. 20. Free-space coupling structure 530 redirects light out of the first waveguide 520. Free-space coupling structure 530 may comprise any structure adapted to redirect light into free space. In an exemplary embodiment, free-space coupling structure 530 is a structure substantially as described above with respect to free-space coupling structure 330.

It will be understood that optical interconnect system 500 is not limited to the above components, but may include additional components, as would be understood by one of ordinary skill in the art from the description herein.

Optical interconnect system 500 may include one or more coupling structures 130, as described above with respect to system 100. Coupling structures 130 may redirect light onto modulators (not shown), as described above with respect to system 100. Additionally, Optical interconnect system 500 may include a photodetector (not shown), substantially as described above with respect to system 100. The photodetector may be configured to receive the light redirected into waveguide 520 by light-redirecting element 525.

Optical interconnect system 500 may include a reflective element 540 positioned between substrate 510 and free-space coupling structure 530, as described above with respect to system 300. In an exemplary embodiment, reflective element 540 is a reflective element substantially as described above with respect to reflective element 340.

Optical interconnect system 500 may include a light source (not shown). The light source provides the light that propagates through waveguide 520. In an exemplary embodiment, the light source provides light that propagates in a first direction substantially perpendicular to substrate 510. The light source may be directly integrated in the substrate such as, for example, a surface-mounted light emitting diode. The light source may also be provided by a light source disposed below or above the substrate, in which cases light from the light source may be coupled into the waveguide's substrate by an input coupling system, for example, a lens integrated in the waveguide's or the light source's substrate or a lens positioned between the two substrates.

Optical interconnect system 500 may further include a second waveguide (not shown), substantially as described above with respect to system 300.

Optical interconnect system 500 may further include free-space optical elements (not shown), substantially as described above with respect to system 300.

The operation of optical interconnect system 500 will now be described. A light source is configured to provide a light that propagates in a first direction substantially perpendicular to substrate 510. The light is redirected into waveguide 520 by light-redirecting element 525. The light then propagates through waveguide 520 in a second direction different from the first direction. The light contacts free-space coupling structure 530, and is redirected out of waveguide 520 in a third direction. The third direction may or may not be different from the first and second directions. Other directions may also be achieved by properly configuring free-space coupling structure 530. Free-space coupling structure 530 may be configured such that substantially all of the light contacting free-space coupling structure 530 is redirected out of waveguide 520.

System 500 may be fabricated using any of the fabrication techniques described above with respect to systems 100 and 300.

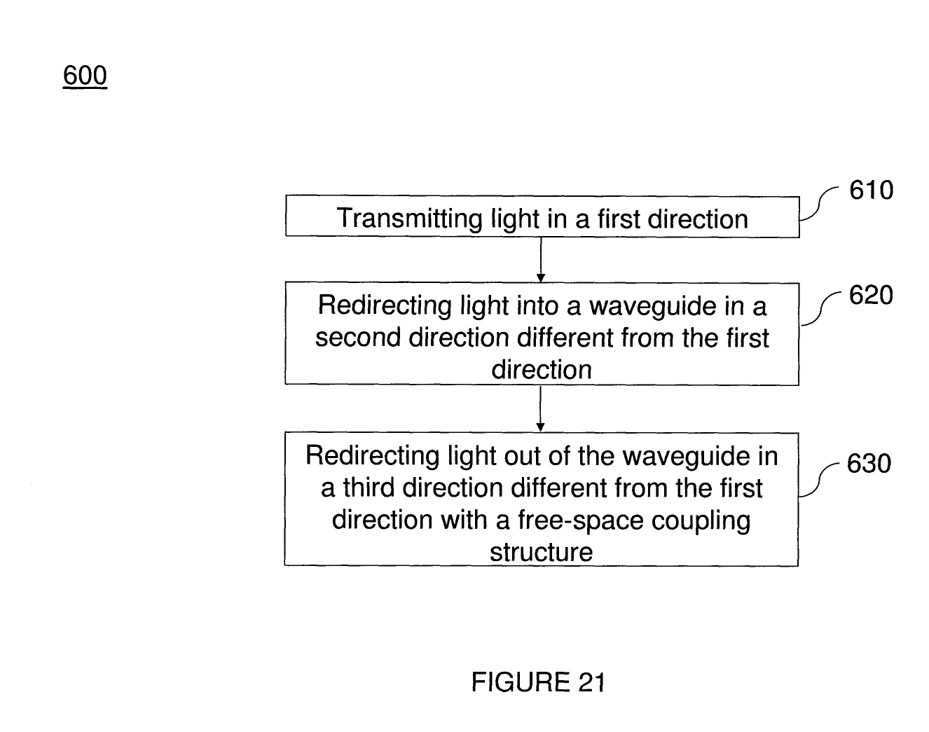

FIG. 21 illustrates a flow chart depicting another exemplary optical interconnect method 600 in accordance with aspects of the present invention. Method 600 may be performed with an integrated circuit chip. Method 600 may be performed by itself or in conjunction with method 200 and 400. As a general overview, method 600 includes transmitting light, redirecting light into a waveguide, and redirecting the light out of the waveguide. To facilitate description, the steps of method 600 are described herein with reference to the components of system 500.

In step 610, light is transmitted in a first direction. In an exemplary embodiment, light is emitted from a surface-normal light source. The light may propagate in a first direction substantially perpendicular to substrate 510. The light may be provided by a light source directly integrated in substrate 510. The light source may also be provided by a light source disposed below or above substrate 510, in which cases light from the light source may be coupled into the waveguide's substrate by an input coupling system, for example, a lens integrated in the waveguide's or the light source's substrate or a lens positioned between the two substrates.

In step 620, the light is redirected in a second direction different from the first direction and may be transmitted through a waveguide. The second direction may be substantially parallel to the substrate. In an exemplary embodiment, light-redirecting element 525 reflects light into waveguide 520. Light-redirecting element 525 may be a 45 degree reflective element. Light-redirecting element 525 may comprise a tapered end of waveguide 520 having a reflective coating to promote total internal reflection (TIR).

In step 630, the light is redirected out of the waveguide. In an exemplary embodiment, free-space coupling structure 530 redirects light out of the waveguide 520 in a third direction. The third direction may be substantially different from the first and second directions. Substantially all of the light contacting the free-space coupling structure 530 may be redirected out of the waveguide 520.

It will be understood that optical interconnect method 600 is not limited to the above steps, but may include additional steps, as would be understood by one of ordinary skill in the art from the description herein.

The optical interconnect systems and methods described herein may be usable to overcome drawbacks in prior art technologies. Previous technologies used reflective facets coated with metallic coatings, which may introduce loss. Additionally, in order to deliver the light from a source to a modulator and from the modulator to a photodetector, previous architectures combined multiple optical elements to manipulate the beam between different parallel planes (i.e. modulator layer, CMOS circuit layer, waveguide layer, etc.) with surface normal devices. This resulted in relatively large optical interconnect structures, which leads to relatively low link density. Introduction of multiple optical elements to deliver the light beam may increase the complexity of the structure and the fabrication process, requires high alignment accuracy and introduces additional losses due to multiple interfaces.

The systems and methods of the present invention are particularly suitable for overcoming these drawbacks. The use of total internal reflections may reduce the reflection losses while efficiently redirecting the beam downwards to the modulator. The configuration in which the coupling structures are embedded in waveguides may significantly decrease the footprint of the existence of the optical interconnect fabric and therefore increases the optical link density that can be achieved in a certain area. The minimization of structure layers and components may also simplify the fabrication process and significantly reduces the cost.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. An optical interconnect system comprising:
a substrate;
a first waveguide disposed on the substrate, and
a free-space coupling structure adjacent the first waveguide to redirect light propagating through the first waveguide in a first direction out of the first waveguide in a second direction different from the first direction.

2. The optical interconnect system of claim 1, wherein the free-space coupling structure redirects the light out of the first waveguide into a free space, the free space absent a waveguide.

3. The optical interconnect system of claim 1, wherein:
substantially all of the light that contacts the free-space coupling structure is redirected out of the first waveguide.

4. The optical interconnect system of claim 1, wherein
the first direction is substantially parallel with a surface of the substrate, and
the second direction is substantially normal to the surface of the substrate.

5. The optical interconnect system of claim 1, wherein
the free-space coupling structure comprises a prismatic structure.

6. The optical interconnect system of claim 1, wherein
the free-space coupling structure comprises an end surface of the first waveguide, the end surface angled with respect to a perpendicular cross-section of the first waveguide.

7. The optical interconnect system of claim 1, further comprising:
a reflective element positioned between the substrate and the free-space coupling structure.

8. The optical interconnect system of claim 7, wherein
the reflective element is an optical modulator.

9. The optical interconnect system of claim 1, further comprising:
a light source configured to supply the light; and
an input coupling system for coupling the light from the light source into the optical waveguide.

10. The optical interconnect system of claim 1, further comprising:
a second waveguide,
wherein the free-space coupling structure redirects the light toward the second waveguide for coupling into the second waveguide.

11. The optical interconnect system of claim 10, wherein
the first waveguide is positioned in a first plane substantially parallel with a surface of the substrate, and
the second waveguide is positioned in a second plane substantially parallel with the surface of the substrate, the second plane spaced from the first plane.

12. The optical interconnect system of claim 10, further comprising:
another free-space coupling structure adjacent the second waveguide for coupling the light redirected out of the first waveguide into the second waveguide.

13. An optical interconnect method, the method comprising the steps of:
transmitting light through a first waveguide in a first direction; and
redirecting the light out of the first waveguide in a second direction different from the first direction with a free-space coupling structure disposed in the first waveguide.

14. The method of claim 13, wherein the redirecting step comprises:
redirecting substantially all of the light out of the first waveguide.

15. The method of claim 13, wherein a light source supplies the light and wherein the method further comprises the step of:
coupling the light from the light source into the first waveguide with an input coupling system.

16. The method of claim 13, further comprising the step of:
coupling the light redirected out of the first waveguide into a second waveguide.

17. The method of claim 16, wherein the coupling step comprises:
coupling the light redirected out of the first waveguide into the second waveguide with a free-space coupling structure adjacent the second waveguide.

18. An optical interconnect system comprising:
a substrate;
a waveguide disposed on the substrate;
a light-redirecting element disposed adjacent the waveguide, the light-redirecting element configured to direct light propagating in a first direction in a second direction into the waveguide; and
a free-space coupling structure adjacent the waveguide, the free-space coupling structure configured to redirect light propagating through the waveguide in the second direction out of the waveguide in a third direction different from the first and second directions.

19. An optical interconnect method, the method comprising the steps of:
transmitting light in a first direction with a light source;
redirecting light into a waveguide with a light-redirecting element, the light-redirecting element redirecting the light in a second direction different from the first direction; and
redirecting the light out of the waveguide with a free-space coupling structure, the free-space coupling structure redirecting the light in a third direction different from the first and second directions.
